(19) United States
(12) Patent Application Publication
(10) Pub. No.: US 2010/0263259 A1
(43) Pub. Date: Oct. 21, 2010

(54) FISHING LURE, METHOD OF MAKING A FISHING LURE AND A FISHING LURE KIT

(76) Inventor: KENZIE CUTHBERT, Cowichan Lake (CA)

Correspondence Address: J. GORDON THOMSON, P.O. BOX 8865, VICTORIA, BC, V8V 3Z1, CA

(21) Appl. No.: 12/425,360

(22) Filed: Apr. 16, 2009

(51) Int. Cl. A01K 85/08; A01K 85/00

(52) U.S. Cl. 43/42.25; 43/42.34; 43/42.37; 43/42.53; 43/42.24

(57) ABSTRACT

A fishing lure kit contains material for making fishing lures. The lures comprise, in combination, a hook, an eye assembly and a camouflage assembly for mimicking a live prey animal. The eye assembly comprises one flexible heat shrink tube having a first end and a second end. A bead is inserted into each end of the tube. Heat is applied to encapsulate the beads in the tube ends forming an eye assembly. The eye assembly is mounted to a hook and then camouflage is applied to create a prey animal. In another embodiment, two flexible heat shrink tubes are employed. A bead is mounted into one end of each tube and the opposite end of the tube is mounted to a rack to retain its pre-heat diameter after heat is applied. The eye assemblies are threaded onto the hook and overlap each other so that their respective eye stalks protrude in opposite directions. Camouflage material is added to finish the lure.

### CROSS-REFERENCE TO RELATED APPLICATIONS

Not applicable.

### BACKGROUND

1. Field of the Invention

This invention relates to artificial bait and in particular to a fishing lure, method of making a fishing lure and fishing lure kit.

2. Description of the Prior Art

Fishing is a sport enjoyed by millions of people. Many people who fish enjoy the challenge of making their own lures. One aspect of making a lure which is very important to creating a live looking prey animal is its eyes. There are a large number of fishing lure designs and kits on the market. Some provide for eyes that are painted onto hook covers. Others provide for eyes that are mounted onto rigid stems. None provide for the creation of an eye assembly that can mimic a prey animal having eyes mounted to flexible eye stalks.

### SUMMARY

In accordance with the present invention a fishing lure comprises, in combination, a hook, a flexible eye assembly and a camouflage assembly for mimicking a prey animal. The hook comprises a barbed head, a linear shaft and an eyelet for attachment to a filament. The eye assembly comprises at least one flexible shrink tube having a first end and a second end. A single bead mimicking an eye is mounted in said the two ends of the tube. Heat is applied to shrink the tube over the beads thereby permanently encapsulating them in the tube ends. The finished eye assembly is mounted to a hook and fixed in place using a camouflage assembly.

In another embodiment of the invention the eye assembly comprises a first and second shrink tubes with a single bead in one end only. The first and second tubes are exposed to heat so as to shrink the tubes around the beads thereby encapsulating them within the tube end. The individual tubes are mounted onto the shaft of a hook by piercing the non-beaded end with the hook barb and sliding the tubes over the hook shaft. The first mounted tube non-beaded end is mounted over the second mounted tube non-beaded end. Heat is applied to fix the tubes into place. The tubes can be rendered malleable by adding heat so that they can be configured in a life-like manner to resemble eyes mounted to eye stalks of common prey animals. Suitable camouflage material is then added to the hook to create a prey animal.

### OBJECTS AND ADVANTAGES OF THE INVENTION

Accordingly, besides the objects and advantages of the fishing lure described in this description, several objects and advantages of the present invention are:
1. The invention is environmentally benign since toxic lead beads or shot are not used;
2. The beads add ballast to the lure for fishing specific water columns while the tubes provide some buoyancy to the lure when bottom fishing;
3. The resulting lure is very realistic;
4. The lure is simple and inexpensive to manufacture;
5. The lure is easy to use; and,
6. The lure creates less of a splash when entering the water and so does not frighten fish.

Still further objects and advantages will become apparent from a consideration of the ensuring description and drawings.

### DESCRIPTION OF THE DRAWING FIGURES

FIG. 1 is one example of a fishing lure of one embodiment of the invention.

FIG. 2 is a length of shrink tube of one embodiment of the invention.

FIG. 3 is length of shrink tube having a bead in each end in pre-heat configuration.

FIG. 4 is the length of shrink tube of FIG. 3 in post-heat configuration.

FIG. 5 is a hook and assembly combination of one embodiment of the invention.

FIG. 6 illustrates a variety of beads used in one embodiment of the present invention.

FIG. 7 is another example of a fishing lure of one embodiment of the invention.

FIG. 8 illustrates the construction of an eye stalk of one embodiment of the invention.

FIG. 9 illustrates a post-heat eye stalk of one embodiment of the invention.

FIG. 10 illustrates a top view of the tube holding rack of one embodiment of the invention.

FIG. 11 illustrates the placement of eye stalks one a hook of one embodiment of the invention.

FIG. 12 illustrates the placement of the first eye stalk over the second eye stalk in one embodiment of the invention.

FIG. 13 illustrates a pre-heat positioning of two eye stalks on a hook of one embodiment of the invention.

FIG. 14 illustrates placement of the eye stalks in a desired configuration of one embodiment of the invention.

### DETAILED DESCRIPTION

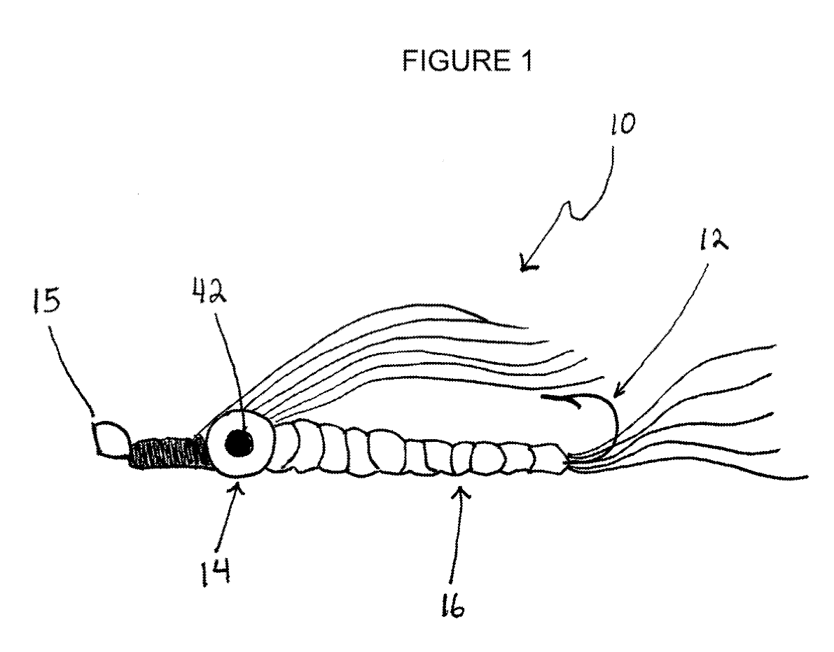

Referring to FIG. 1, there is shown one preferred embodiment of my invention 10 which is a fishing lure in an assembled state comprising, in combination, a hook 12, an eye assembly 14, an eyelet 15 for attachment to a filament and a camouflage assembly 16 for mimicking a prey animal. The eye assembly may include a pupil 42 to give a living appearance to the lure.

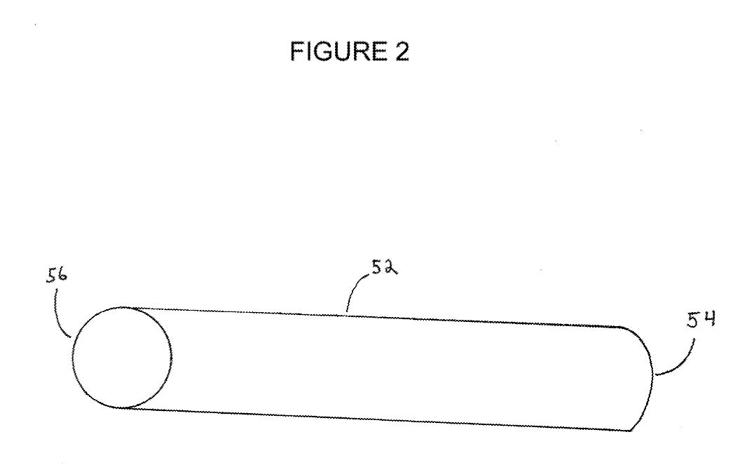

Referring to FIG. 2, the fishing lure of FIG. 1 is constructed from a kit of parts which includes a plurality of lengths of shrink tube 52. The shrink tube is used in the construction of the eye assembly 14 in FIG. 1. The shrink tube includes a first open end 54 and a second open end 56.

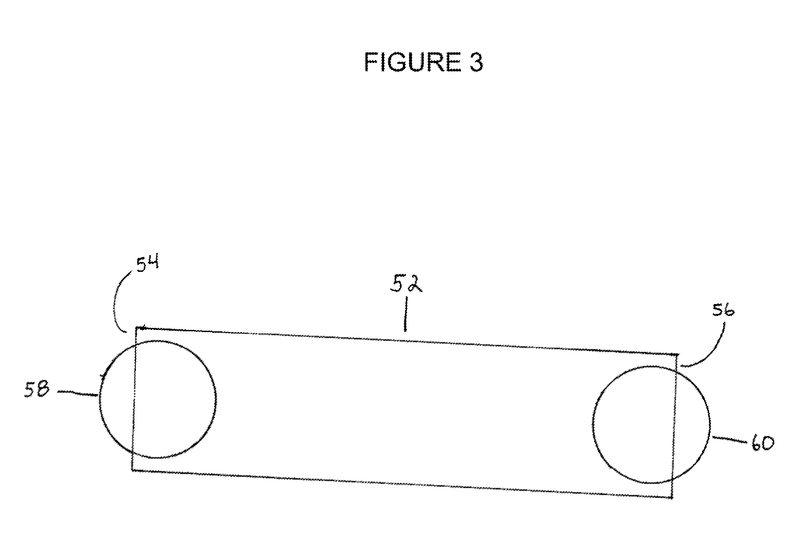

Referring to FIG. 3, bead 58 is inserted into end 54 and bead 60 is inserted into end 56 of tube 52. The beads are shown having an exaggerated smaller diameter than the shrink tube ends so that they fit inside the tubes snugly without falling out or moving down the tube. The tube and beads are shown in their pre-heat configuration with the tube having a pre-heat diameter.

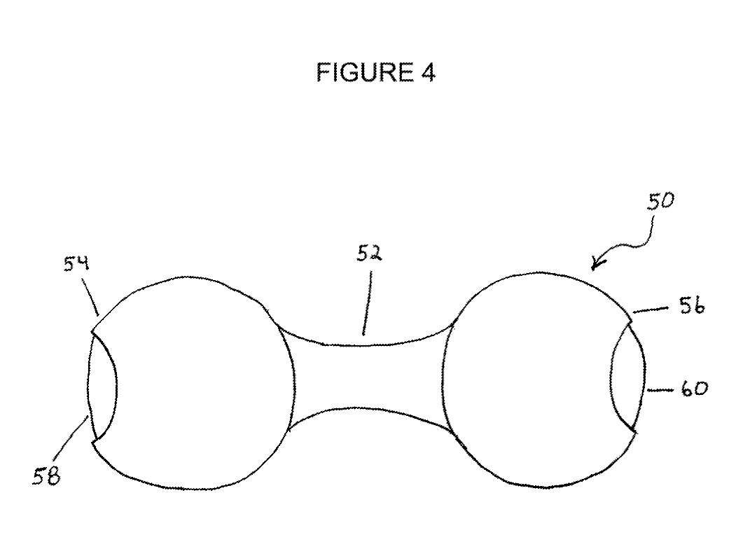

Referring to FIG. 4, heat is applied to the shrink tube 52 by way of a heat gun. This causes the diameter of the tube to shrink to a post-heat configuration so that beads 58 and 60 are encapsulated inside of ends 54 and 56. A portion of the bead circumference is exposed outside of the tube ends to give the effect of an eye of a prey animal. The middle portion of tube 52 between the two beads assumes a post-heat diameter and remains flexible.

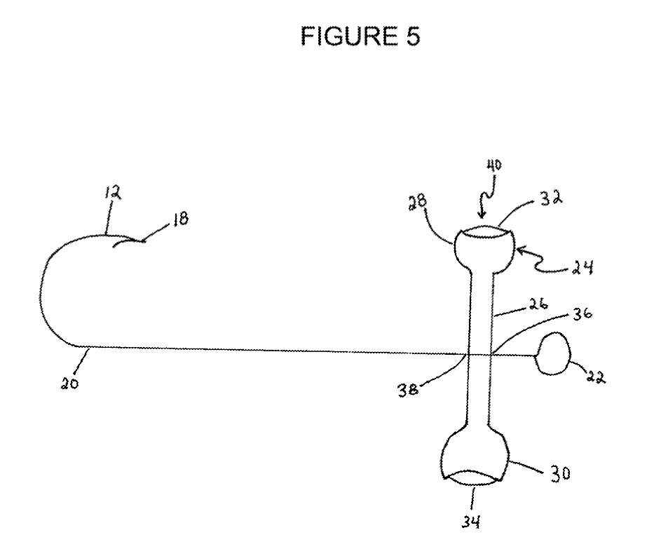

Referring now to FIG. 5, there is shown one embodiment of an eye assembly 24 being mounted over a hook in order to assemble the finished lure. The hook 12 comprises a barbed head 18, a linear shaft 20 and an eyelet 22 for attachment to a filament.

FIG. 5 illustrates an eye assembly 24 comprising a single flexible tube 26 and two beads 32 and 34 encapsulated in each end 28 and 30 of tube 26. The eye assembly 24 is mounted over the linear shaft 20 of the hook at a mid-point 36 on the tube 26 and positioned at a desired location 38 on the linear shaft 20.

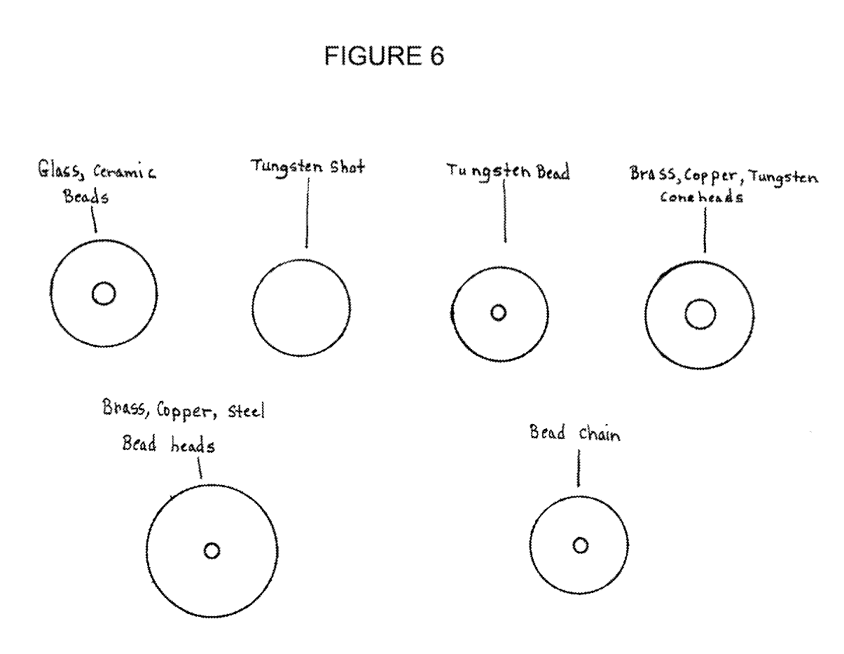

Referring back to FIG. 1, the camouflage assembly 16 is created in a traditional fly manufacturing manner. These materials are also provided in my kit. The result is a lure that mimics a prey animal have protruding eyes mounted on stalks from each side of the body. The camouflage assembly is also used to secure the tube 26 to the linear shaft 20 of the hook. The tube is pierced by the hook. Once the lure is wrapped in camouflage material it will still retain air to assist in buoyancy control of the lure. As shown in FIG. 1, the bead may have features which mimic a pupil 42 and the bead may be of varying colours, sizes and weights. Varying the weight of the eye also helps control the buoyancy of the lure as some float on the surface of the water and others are adapted to sink to the bottom of a water body. A variety of bead sizes and types are illustrated in FIG. 6. The beads are made from non-leaded materials to avoid environmental contamination of the water and of the fish. The beads can be made from glass, ceramic, tungsten shot, tungsten bead, brass, copper, steel beads, chain beads and cone heads. The beads have different weights, diameters, patterns and colours to provide different buoyancy and variety in design. Some of the beads will have holes through their centres and these must be plugged so that air remains trapped inside the tube for buoyancy.

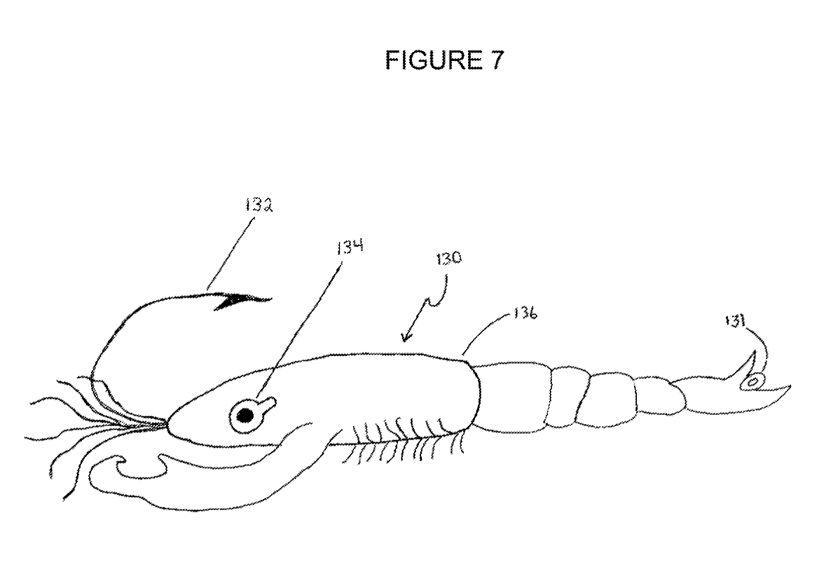

Referring to FIG. 7, there is shown a finished lure of another preferred embodiment of my invention. In this case, the lure 130 is in the shape of a crustacean such as a crayfish which is a popular prey animal for many fish species. The carapace 136 of the crayfish may be a single piece mounted over a hook 132. The finished assembly is tied to a filament by way of eyelet 131 hidden in the tail of the prey animal. In this embodiment, the eye assembly 134 is assembled differently from the previous embodiment as more fully explained below.

Referring back to FIG. 2, the construction of the eye assembly of my invention starts with a length of shrink tube 52 having end 54 and end 56. The shrink tube can have any desired length and my kit will contain a variety of lengths of shrink tube or a roll of shrink tube so a person can cut desired lengths from the roll.

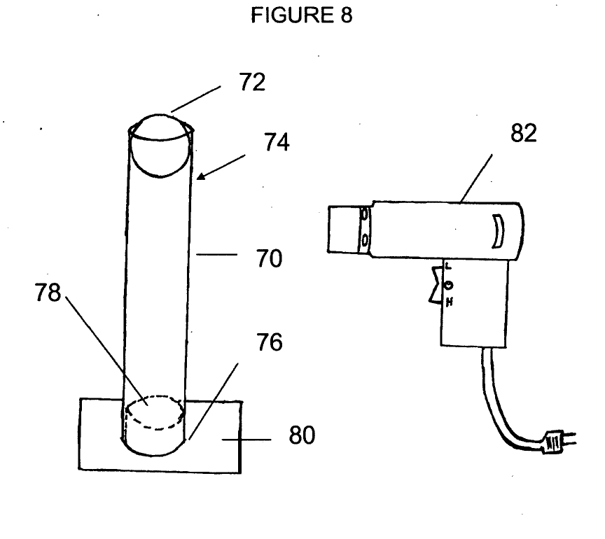

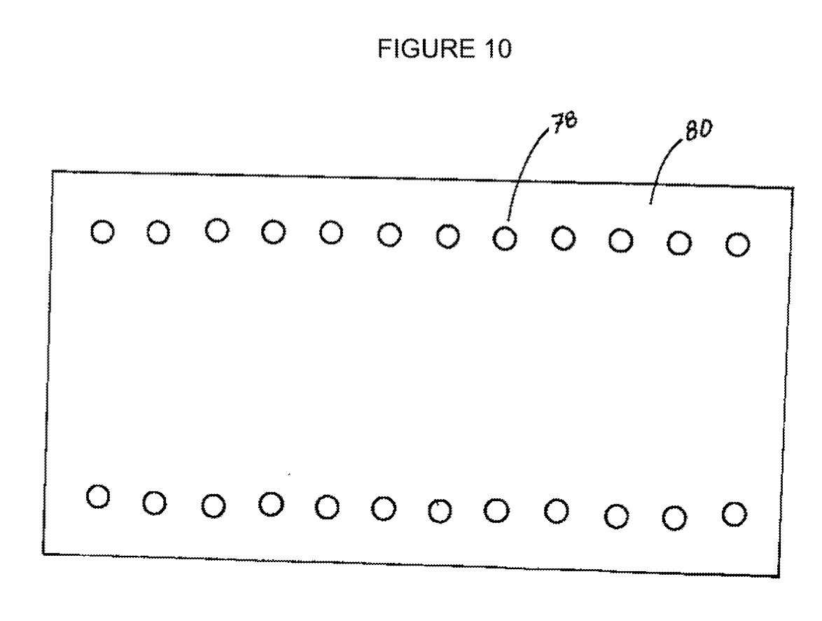

Referring to FIG. 8 and FIG. 10, there is shown a tube 70 in a pre-heat configuration with each end 74 and 76 having a pre-heat diameter. A single eye bead 72 is placed in one end 74 of the tube so that it is snug and will not fall out during movement or sink lower into the tube when upright as illustrated. The opposite end 76 of the tube is inserted into a tube holding rack 80 and inside of a hole 78 drilled into a block of Teflon® having a diameter about equal to the pre-heat diameter of the tube so that it is a snug fit. The hole shown here is exposed for illustrative purposes. Heat is applied using a heat gun 82 so that the shrink tube can assume its post-heat configuration.

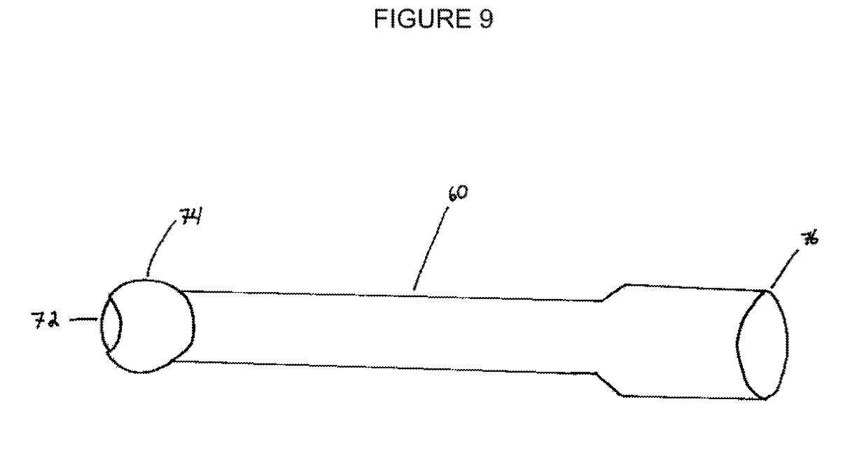

Referring to FIG. 9, there is shown a tube 60 in a post-heat configuration. The bead 72 is encapsulated within the first end 74 of the tube. The second end 76 of the tube retains its pre-heat diameter.

Referring to FIG. 10, there is shown a rack 80 made from Teflon® and comprising a plurality of holes 78 that are used to heat treat a plurality of tubes.

A second tube is completed for a second eye so that there are two post-heat tubes of the configuration illustrated in FIG. 9.

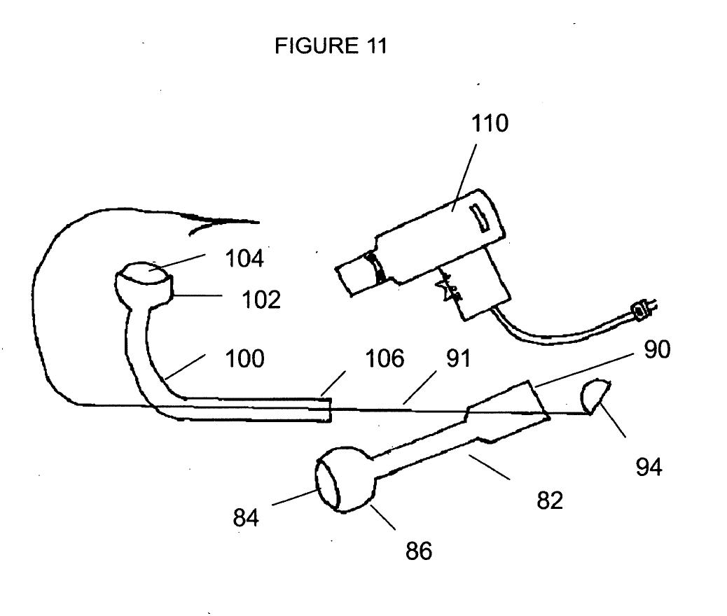

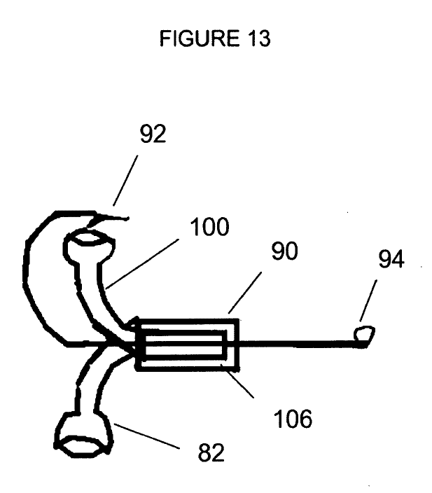

Referring to FIG. 11, to construct a fishing lure that mimics a two-eyed prey animal as shown in FIG. 13, a first post-heat tube 82 having a bead 84 at a first end 86, an intermediate eye stalk 88 and a second end 90 is positioned on the linear shaft 91 by threading the second end 90 over the barbed head 92 by piercing the second end 90 and moving it over the hook and up the linear shaft to the eyelet 94. The first tube 82 is kept in that position to permit the installation of the second tube 100 having a first end 102 in which there is encapsulated a bead 104. The second end 106 of the second tube is threaded on to the linear shaft 91 in the same manner as the first tube 82. Once the second tube is positioned in a desirable position, the heat gun 110 is used to apply heat to the second end 106 so that it contracts about the linear shaft 91 and is fixed permanently in place.

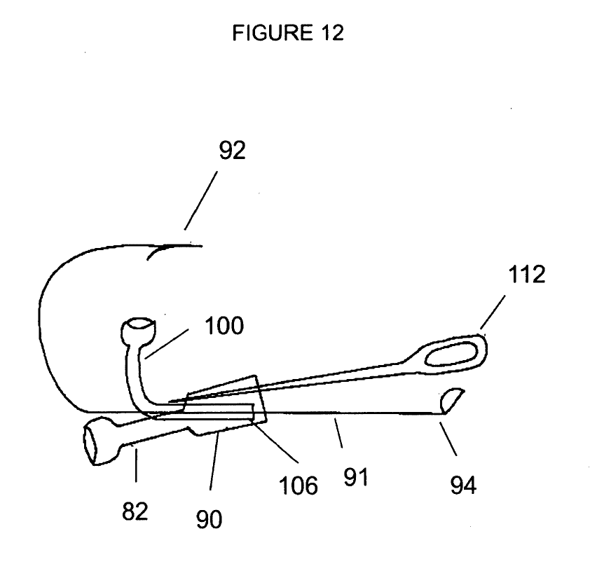

Referring to FIG. 12, the first tube 82 is then moved down the linear shaft 91 until the second end 90 of the first tube 82 is over the second end 106 of the second tube 100. The orientation of the linear shaft, first tube second end and second tube second end is generally co-axial. A pin 112 can be used to manipulate the first tube second end into position over the second tube second end.

Referring to FIG. 13, once the second end 90 of the first tube 82 is placed over the second end 106 of the second tube 100 the heat gun is used to shrink the second end of the second tube over the second end of the first tube thereby fixing both tubes permanently to the linear shaft of the hook in a desired location.

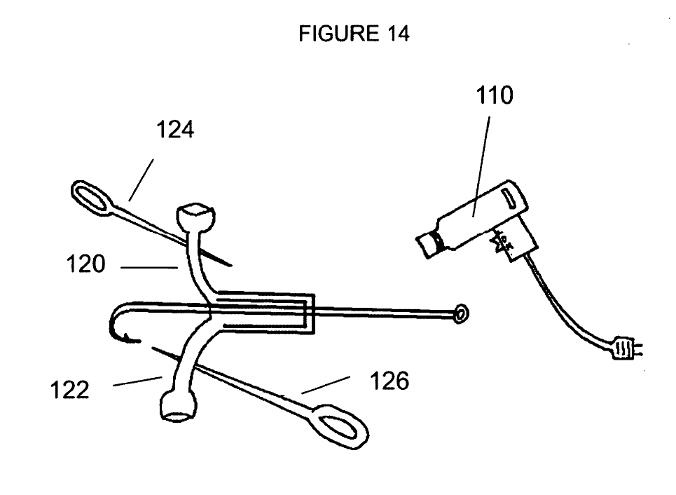

Referring to FIG. 14, once the tubes are fixed to the hook, the heat gun 110 can be used to soften the stalks 120 and 122 of the first and second tubes respectively so that they can be positioned to resemble a living prey-animal in as life-like simulation as possible. Pins 122 and 124 are used to gently move the stalks to a desired curvature and position.

Advantageously using my invention it is possible to design and easily manufacture a variety of different lures ranging from flies as shown in FIG. 1 to simulated crustaceans as shown in FIG. 7.

From the description above, a number of advantages of my invention are:
1. The invention creates a limitless variety of configurations of prey-animals;
2. The invention eliminates the use of toxic weights and beads;
3. The invention is easily adapted to kit form; and,
4. The invention creates eye assemblies having flexible stalks that better mimic the live prey animal.

One method of making the invention, namely, a fishing lure for mimicking a prey animal having a dual eyestalk, comprises the following steps:
a. Selecting a fishing hook comprising a barbed head, a linear shaft and an eyelet for attachment to a filament;
b. Selecting a first length of heat sensitive shrink tubing having a first end, a second end and an intermediate length forming the eye stalk, wherein the tubing has a pre-heat diameter and a smaller post-heat diameter;
c. Inserting a single bead into the first end and the second end;
d. Applying heat to the first length of heat sensitive shrink tube so that the beads are encapsulated into the first and second ends of the tube and so the that length of tube between the eyes forms eye stalks for each of the eyes;
e. Threading the post-heat tube with beads over a desired location on the hook linear shaft;
f. Fixing the post-heat tube to the linear shaft using fixing means;
g. Fixing camouflage to the hook and eye assembly so as to mimic the form of a living prey animal.

The method of making a lure having two individual eye stalks comprises the steps of:
a. Selecting a fishing hook comprising a barbed head, a linear shaft and an eyelet for attachment to a filament;
b. Selecting a first length of heat sensitive shrink tubing having a first end, a second end and an intermediate length and having a pre-heat diameter and a smaller post-heat diameter;
c. Inserting a single bead into said first end and placing said second end into a circular hole on a Teflon® rack having a diameter equal to the pre-heat diameter, wherein the circular hole is one of a plurality of circular holes drilled into the rack;
d. Selecting a second length of heat sensitive shrink tubing having a first end, a second end and an intermediate length and having a pre-heat diameter and a smaller post-heat diameter;
e. Inserting a single bead into said second length first end and placing said second length second end into a second circular hole having a diameter equal to said pre-heat diameter;
f. Applying heat to said first and second lengths of heat sensitive shrink tube so that said first and second single beads are encapsulated into the first ends of the first and second tube lengths and so that the first and second intermediate lengths adapt a post-heat diameter and forms the first and second eye stalks, and further wherein the first and second length second ends retain a pre-heat diameter;
g. Placing the first length second end over said barbed head of the hook so that the hook pieces the second end and positioning the second end at a desired location on said linear shaft so that the bead within the mounted tube protrudes away from the linear shaft;
h. Applying heat to the first mounted tube so that the second end contracts and fixes permanently to the linear shaft;
i. Placing the second length second end over said barbed head of the hook so that the hook pierces the second length second end and positioning the second end over the first length second end so that the bead within the second mounted tube protrudes away from the linear shaft;
j. Applying heat to the second mounted tube so that the second tube second end contracts and fixes permanently to the linear shaft over the first tube second end;
k. Applying heat to the fixed first and second tubes and forming the first and second eye stalks to mimic the eye stalks of a prey animal; and,
l. Fixing said camouflage assembly to the hook so as to mimic the form of a living prey animal.

The invention is readily adaptable to kit form and would make. A kit for making a fishing lure mimicking a prey animal with at least one protruding eye mounted on an eye stalk comprises:
a. A plurality of hooks of varying sizes, wherein each hook comprises a barbed head, a linear shaft and an eyelet for fastening to a filament;
b. A plurality of heat sensitive shrink tubes having varying lengths and diameters;
c. A plurality of beads for mimicking eyes, wherein each of the beads is insertable into at least one end of said plurality of heat sensitive shrink tubes and wherein the beads have different weights, colours, diameters and comprises different materials;
d. A plurality of lure camouflage material comprising feathers, tie string and a variety of artificial prey animal bodies adapted for attachment to said linear shaft of the hook; and,
e. Instructions for making fishing lure using the aforementioned material.

In one embodiment of the invention, the kit includes a heat gun.

In another embodiment of the invention the kit includes a case for containing the various materials.

Although the description above contains much specificity, there should not be construed as limiting the scope of the invention but merely providing illustrations of some of the presently preferred embodiments of this invention. For example, the camouflage for the lures can comprise a variety of prey animals shapes. The hooks can be single or multi-barbed. The beads for eyes can comprise other colours and materials not explicitly described herein. Thus the scope of the invention should be determined by the appended claims and their legal equivalents rather than by the examples given.

What is claimed is:

1. A fishing lure comprising, in combination, a hook, an eye assembly and a camouflage assembly for mimicking a live prey animal, wherein said hook comprises a barbed head, a linear shaft and an eyelet for attachment to a filament, and wherein said eye assembly comprises one flexible tube having a first end and a second end, and further wherein a first bead is mounted in said first end and a second bead is mounted in said second end.

2. The fishing lure of claim 1, wherein said one flexible tube is a heat sensitive shrink tube having a first pre-heat diameter and a second smaller post-heat diameter.

3. The fishing lure of claim 2, wherein the first and the second beads are inserted into the first end and second end of the heat sensitive shrink tube, wherein the shrink tube has a pre-heat diameter, and wherein a portion of the first and second beads protrude from the first and second ends.

4. The fishing lure of claim 3, where upon the application of heat the first end and the second end of the shrink tube contracts to a post-heat diameter thereby encapsulating the first and the second beads inside the ends of the shrink tube thereby forming said eye assembly.

5. The fishing lure of claim 4 wherein said eye assembly is mounted over said hook shaft at a desired location and fixed thereto by fixing means.

6. The fishing lure of claim 1, wherein the eye assembly comprises a first and a second flexible heat sensitive shrink tubes having respective first and second ends and respective pre-heat diameters and smaller post-heat diameters.

7. The fishing lure of claim 6, wherein a single bead is mounted in the first end of each of the first and second flexible heat sensitive shrink tubes and the second ends of the first and second flexible heat sensitive shrink tubes are mounted into a circular hole in a rack comprising a plurality of identical circular holes, and wherein said circular hole has a diameter equal to the pre-heat diameter of the heat sensitive shrink tube, and wherein there is an intermediate length of shrink tube between the second hole mounting end and the first bead mounting end.

8. The fishing lure of claim 7, where upon the application of heat the first end of the first and second shrink tubes contracts to a post-heat diameter thereby encapsulating the bead inside the first end of each shrink tube, and wherein the first and second tube second ends retains a pre-heat diameter, and wherein the intermediate length forms the eye stalk of the first and second tubes.

9. The fishing lure of claim 8, wherein the second end of the first tube is mounted over said hook and onto the linear shaft at a desired location so that the linear shaft and the second end are co-axial.

10. The fishing lure of claim 9, wherein the second end receives heat so that it contracts in diameter sufficient to permanently fix to the linear shaft.

11. The fishing lure of claim 10, wherein the second end of the second tube is mounted over the second end of the first tube, and wherein the second end of the second tube receives heat so that it contracts over the second end of the first tube thereby permanently fixing the second ends of the first and second tubes to the linear shaft.

12. The fishing lure of claim 1, wherein said bead is selected from a group of beads comprising beads made from the following materials: glass, tungsten, foam, copper shot, brass shot, plastic and ceramic.

13. The fishing lure of claim 12, wherein the bead comprises one of a group of beads comprising a weighted bead and an un-weighted bead so that buoyancy of the lure can be controlled.

14. The fishing lure of claim 13, wherein the intermediate portion of the tube is adapted to contain a volume of air to promote neutral buoyancy of the lure.

15. A method of making a fishing lure for mimicking a prey animal having a first and a second protruding eye mounted on a respective first and second eye stalks, said method comprising the following steps:
a. Selecting a fishing hook comprising a barbed head, a linear shaft and an eyelet for attachment to a filament;
b. Selecting a first length of heat sensitive shrink tubing having a first end, a second end and an intermediate length and having a pre-heat diameter and a smaller post-heat diameter;
c. Inserting a single bead into said first end and placing said second end into a circular hole having a diameter equal to said pre-heat diameter, wherein said circular hole is one of a plurality of circular holes mounted on a rack;
d. Selecting a second length of heat sensitive shrink tubing having a first end, a second end and an intermediate length and having a pre-heat diameter and a smaller post-heat diameter;
e. Inserting a single bead into said second length first end and placing said second length second end onto a second circular hole having a diameter equal to said pre-heat diameter;
f. Applying heat to said first and second lengths of heat sensitive shrink tube so that said first and second single beads are encapsulated into the first ends of the first and second tube lengths and so that the first and second intermediate lengths adapt a post-heat diameter and forms the first and second eye stalks, and further wherein the first and second length second ends retain a pre-heat diameter;
g. Placing the first length second end over said barbed head of the hook so that the hook pierces the second end and positioning the second end at a desired location on said linear shaft so that the bead within the mounted tube protrudes away from the linear shaft;
h. Applying heat to the first mounted tube so that the second end contracts and fixes permanently to the linear shaft;
i. Placing the second length second end over said barbed head of the hook so that the hook pierces the second length second end and positioning the second end over the first length second end so that the bead within the second mounted tube protrudes away from the linear shaft;
j. Applying heat to the second mounted tube so that the second tube second end contracts and fixes permanently to the linear shaft over the first tube second end;
k. Applying heat to the fixed first and second tubes and forming the first and second eye stalks to mimic the eye stalks of a prey animal; and,
l. Fixing said camouflage assembly to the hook so as to mimic the form of a living prey animal.

16. A kit for making a fishing lure mimicking a prey animal with at least one protruding eye mounted on an eye stalk, said kit comprising:
a. A plurality of hooks, wherein each hook comprises a barbed head, a linear shaft and an eyelet for fastening to a filament;
b. A plurality of heat sensitive shrink tubes having varying lengths;
c. A plurality of beads for mimicking eyes, wherein each of the beads is insertable into at least one end of said plurality of heat sensitive shrink tubes;
d. A rack comprising a plurality of circular holes;
e. A plurality of lure finishing material comprising feathers, tie string and a variety of artificial prey animal bodies adapted for attachment to said linear shaft; and,
f. Instructions for making a fishing lure.

17. The kit of claim 16, wherein said plurality of beads are manufactured from materials comprising the following group of materials: plastic, ceramic, tungsten, glass and non-leaded shot, and further wherein the plurality of beads comprises beads having different weights, colours and patterns.

18. The kit of claim 17, further comprising a heat source.
